(19) United States
(12) Patent Application Publication
(10) Pub. No.: US 2015/0310646 A1
(43) Pub. Date: Oct. 29, 2015

(54) GRAPH DISPLAY CONTROL APPARATUS, GRAPH DISPLAY CONTROL METHOD, AND RECORDING MEDIUM STORING GRAPH DISPLAY CONTROL PROGRAM

(71) Applicant: CASIO COMPUTER CO., LTD., Tokyo (JP)

(72) Inventors: Kosuke KAROJI, Tokyo (JP); Kentaro SUZUKI, Tokyo (JP); Anthony HARRADINE, Campbelltown (AU)

(73) Assignee: CASIO COMPUTER CO., LTD., Tokyo (JP)

(21) Appl. No.: 14/690,069

(22) Filed: Apr. 17, 2015

(30) Foreign Application Priority Data
Apr. 24, 2014 (JP) 2014-090610

(51) Int. Cl. G06T 11/20

(52) U.S. Cl. CPC G06T 11/206

(57) ABSTRACT

A graph display control apparatus includes a processor. The processor operations including: storing a function equation in a memory; displaying a graph corresponding to the stored function equation on a coordinate system of a display; designating a plurality of points on the displayed graph in response to user's operations; obtaining a slope value of a tangent to the displayed graph at each coordinate corresponding to each of the plurality of designated points; plotting the corresponding slope values as one value of a coordinate on the coordinate system; performing regression calculation based on the plurality of plotted points to obtain a regression function equation of a graph corresponding to the plurality of plotted points; and displaying a graph corresponding to the regression function equation obtained by the regression calculation on the display.

### CROSS-REFERENCE TO RELATED APPLICATION

This application claims priority based on Japanese Patent Application No. 2014-090610, filed on Apr. 24, 2014, the entire contents of which are incorporated by reference herein.

### BACKGROUND OF THE INVENTION

1. Field of the Invention

The present invention relates to a graph display control apparatus, a graph display control method, and the like for displaying graph images according to function equations.

2. Description of the Related Art

Recently, scientific calculators having a graph drawing function is used to learn mathematics.

### SUMMARY OF THE INVENTION

### Problems that the Invention is to be Solved

There is a graph function calculator which displays the increase/decrease table of functions f(x), f′(x), and f′(x) and which displays the graph image of the function f(x) and the graph image of the function f′(x) obtained by differentiating the function f(x), thereby enabling a user to learn the features of the graph of the differential function f′(x) and the components of the increase/decrease table in association with each other (see JP-A-2005-107908 for instance).

In the graph function calculator according to the related art, since the graph of the function f(x) and the graph of the function f′(x) obtained by differentiating the function f(x) are displayed and the increase/decrease table of the functions f(x) and f′(x) also is displayed, the user can learn their features by directly comparing them.

It is desired to learn while more effectively understanding how the function f(x) and the function f′(x) obtained by differentiating the function f(x) are related to each other.

The present invention was made in view of this matter, and an object of the present invention is to provide a graph display control apparatus and a control program thereof enabling a user to experientially learn while understanding how a function f(x) and a function f′(x) obtained by differentiating the function f(x) are related to each other.

A graph display control apparatus of the present invention includes a processor. The processor operations including: storing a function equation in a memory; displaying a graph corresponding to the stored function equation on a coordinate system of a display; designating a plurality of points on the displayed graph in response to user's operations; obtaining a slope value of a tangent to the displayed graph at each coordinate corresponding to each of the plurality of designated points; plotting the corresponding slope values as one value of a coordinate on the coordinate system; performing regression calculation based on the plurality of plotted points to obtain a regression function equation of a graph corresponding to the plurality of plotted points; and displaying a graph corresponding to the regression function equation obtained by the regression calculation on the display.

### BRIEF DESCRIPTION OF THE DRAWINGS

FIG. 1 is a front view illustrating the configuration of the appearance of a graph function calculator 10 according to an embodiment of a graph display control apparatus of the present invention.

FIG. 2 is a front view illustrating the configuration of the appearance of a tablet terminal 10T having an emulator of the graph function calculator 10, and shows an emulator screen EM of the graph function calculator 10.

FIG. 3 is a block diagram illustrating the circuit configuration of the graph function calculator 10.

FIG. 4 is a flow chart illustrating a part of a differentiation learning control process which is performed by a differentiation mode of the graph function calculator 10.

FIG. 5 is a flow chart illustrating another part of the differentiation learning control process which is performed by the differentiation mode of the graph function calculator 10.

FIGS. 6A to 6C are views illustrating a part of a display operation according to user's operations based on the differentiation learning control process of the graph function calculator 10.

FIGS. 7A to 7C are views illustrating another part of a display operation according to the operations based on the differentiation learning control process of the graph function calculator 10.

FIGS. 8A to 8C are views illustrating another part of a display operation according to the operations based on the differentiation learning control process of the graph function calculator 10.

FIGS. 9A and 9B are views illustrating another part of a display operation according to the operations based on the differentiation learning control process of the graph function calculator 10.

FIGS. 10A to 10C are views illustrating a part of a display operation according to operations based on another embodiment in the differentiation learning control process of the graph function calculator 10.

FIGS. 11A to 11C are views illustrating another part of a display operation according to the operations based on another embodiment in the differentiation learning control process of the graph function calculator 10.

### DETAILED DESCRIPTION OF THE INVENTION

Hereinafter, embodiments of the present invention will be described with reference to the accompanying drawings.

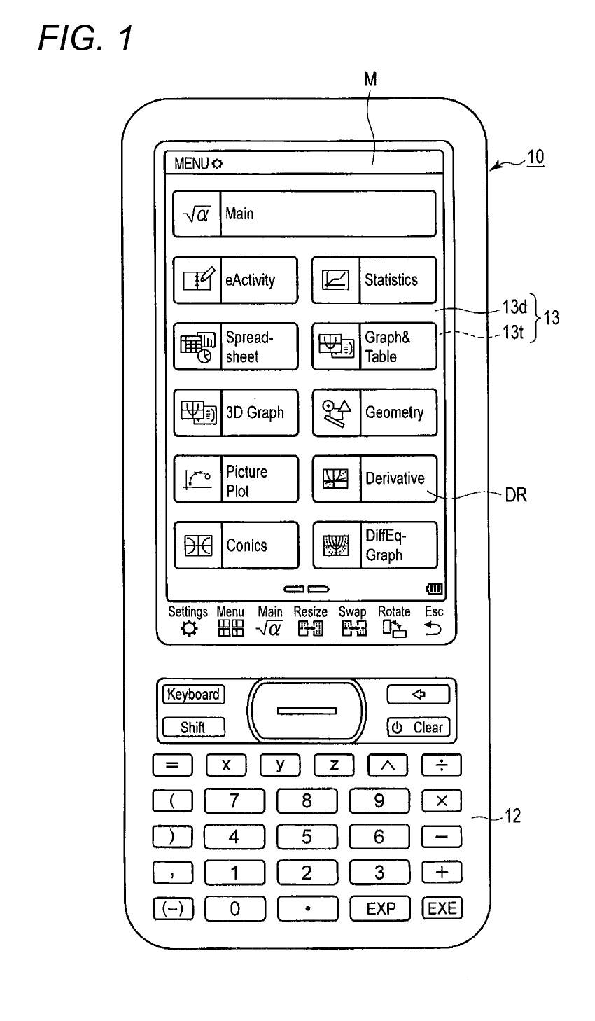

FIG. 1 is a front view illustrating the configuration of the appearance of a graph function calculator 10 according to an embodiment of a graph display control apparatus of the present invention.

This graph display control apparatus is configured as a dedicated graph function calculator 10 to be described below, but may be configured as a device having a graph display function according to function equations, such as a tablet terminal, a mobile phone, or a mobile game device.

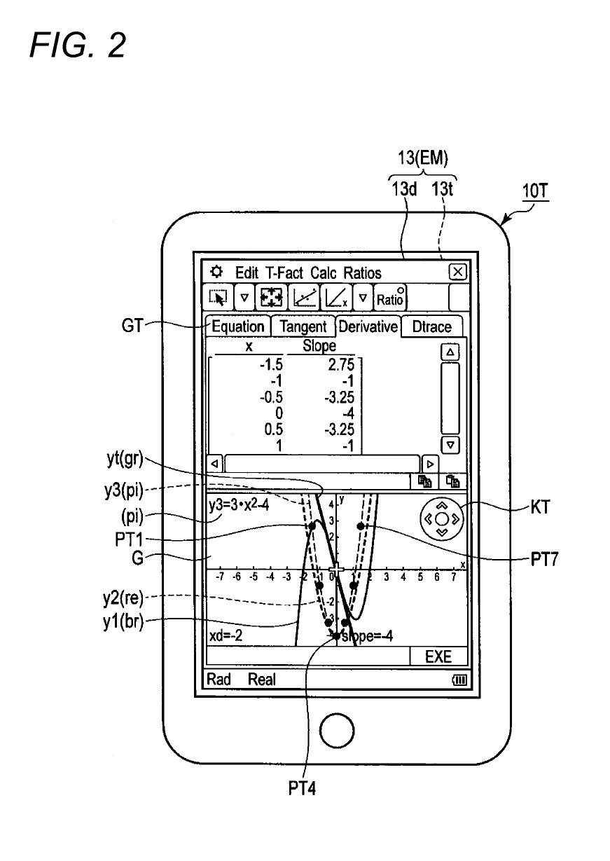

FIG. 2 is a front view illustrating the configuration of the appearance of a tablet terminal 10T having an emulator of the graph function calculator 10, and shows an emulator screen EM of the graph function calculator 10.

This graph function calculator 10 has a function of displaying an input function equation and a graph image according to that function equation.

On the main body of the graph function calculator 10, a key input unit 12 is provided in about its lower half, and a touch panel display 13 is provided in about its upper half.

The key input unit 12 includes number/symbol keys, function/operator keys, cursor keys, and so on.

The number/symbol keys are composed of a number/symbol input key group such that individual keys of numbers, symbols, and the like are arranged.

The function/operator keys are composed of various function symbol keys and operator keys such as “+”, “−”, “×”, “÷”, and “=” which can be operated to input arithmetic equations and function equations.

Also, the touch panel display 13 is configured by putting a transparent touch panel 13t on a liquid crystal display screen 13d capable of color display.

If a menu button [Menu] which is displayed along the upper edge of the touch panel display 13 is touched, a main menu M as shown in FIG. 1 is displayed. And, if any one of various icons displayed in the main menu M is selectively touched, the graph function calculator 10 enters an operating mode of a function according to the touched icon.

In this embodiment, an operating mode (differentiation mode) of a differentiation learning function which is activated by a [Derivative] icon DR will be described.

For example, as shown in FIGS. 2 and 6 to 9, this differentiation mode has a function of displaying a graph y1 corresponding to a function equation y1 which is a differentiation target, a function of designating a point on the graph y1 and displaying a tangent yt to that point, a function of displaying the slopes of tangents yt (that is, differential values) corresponding to the x values (x) of a plurality of individual points, as plot points PT1, PT2, . . . , in accordance with designation of those points on the graph y1, a function of storing the x values (x) of the individual points and the slopes in a tangent slope table GT and displaying them, a function of inputting a function expression y2 of a graph which a user estimates based on positions of the individual plot points PT1, PT2, . . . , a function of displaying a graph y2 corresponding to the input estimation function equation y2, a function of performing regression calculation based on each data item of the tangent slope table GT by an n-the order regression function equation which the user designates based on the positions of the plot points PT1, PT2, . . . , thereby calculating coefficient values (parameters) of the corresponding regression function equation, and a function of displaying a regression function equation y3 obtained by substituting the calculated coefficient values (parameters) for coefficients, and a graph y3 corresponding to the regression function equation y3.

Further, the differentiation mode has a function of displaying the function equation y1 which is a differentiation target, and the graph y1 of the function equation y1 in the same color (here, blue), and displaying the estimation function equation y2 and the graph y2 of the estimation function equation y2 in the same color (red) different from that of the graph y1, and displaying the regression function equation y3 and the graph y3 of the regression function equation y3 in the same color (pink) different from those of the graphs y1 and y2 such that they can be identified.

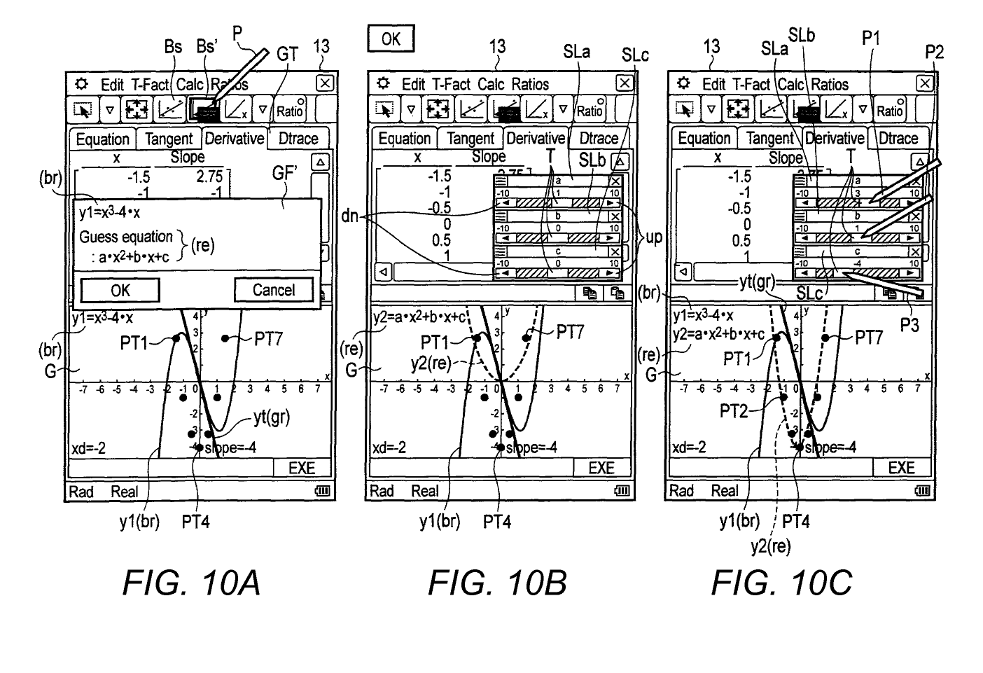

Furthermore, the differentiation mode has other functions such as a function of substituting coefficients a, b, . . . for coefficient values (parameters) which are included in the differential function equation y2 obtained by differentiating the function equation y1 which is a differentiation target, and substituting values set by sliders (operation display objects) SLa, SLb, . . . for the corresponding coefficients a, b, . . . , and a function of displaying the graph y2 corresponding to the coefficient function equation y2 obtained by substituting the values set by the sliders SLa, SLb, . . . for the individual coefficients a, b, . . . , for example, as shown in FIG. 10.

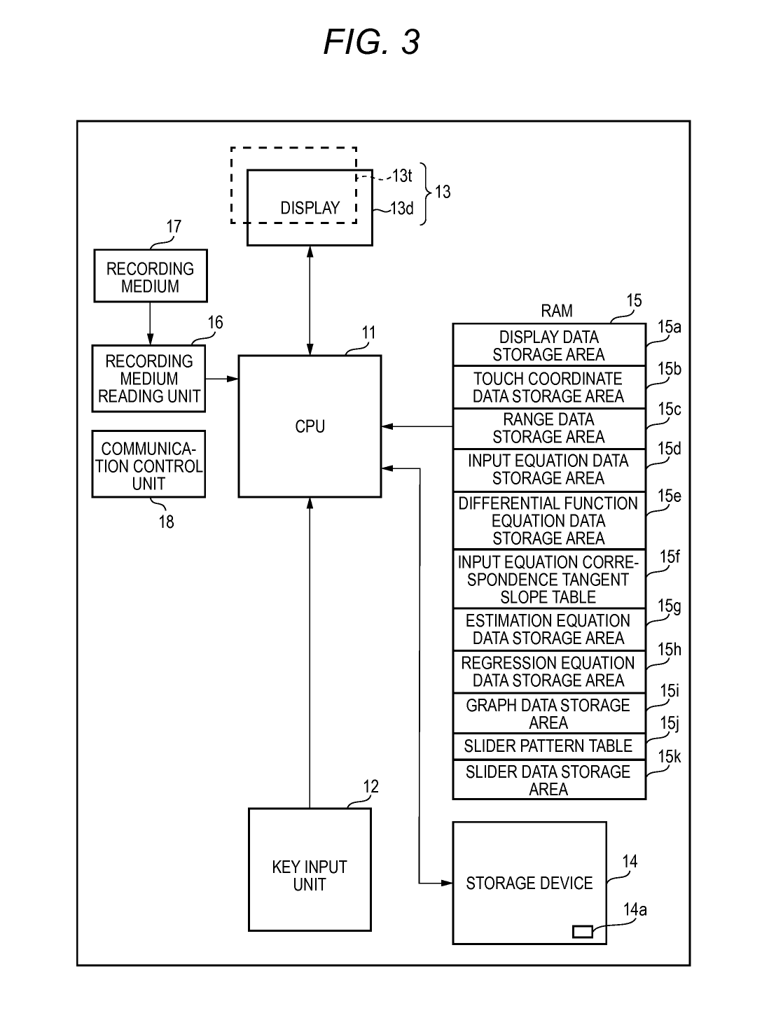

FIG. 3 is a block diagram illustrating the circuit configuration of the graph function calculator 10.

The graph function calculator 10 includes a CPU 11 which is a micro computer.

The CPU 11 uses a RAM 15, as a memory for work, to control operations of individual circuit units according to a calculator control program 14a stored in advance in a storage device 14 such as a flash ROM, or a calculator control program 14a read from an external recording medium 17 such as a memory card into the storage device 14 through a recording medium reading unit 16, or a calculator control program 14a downloaded from a Web server (a program server) on a communication network (the Internet) into the storage device 14 through a communication control unit 18, thereby performing various functions of the graph function calculator 10, such as a calculator function and a function graph drawing function.

The CPU 11 is connected not only to the key input unit 12 and the touch panel display 13 shown in FIG. 1 but also to the storage device 14, the RAM 15, the recording medium reading unit 16, the communication control unit 18, and so on.

The RAM 15 stores various data necessary for processing operations of the CPU 11. This RAM 15 has not only a display data storage area 15a where data to be displayed in color on a screen of the touch panel display 13 is developed, but also a touch coordinate data storage area 15b, a range data storage area 15c, an input equation data storage area 15d, a differential function equation data storage area 15e, an input equation correspondence tangent slope table 15f, an estimation equation data storage area 15g, a regression equation data storage area 15h, a graph data storage area 15i, a slider pattern table 15j, and a slider data storage area 15k.

In the touch coordinate data storage area 15b, coordinate data of a touch position according to a user's operation detected by the touch panel display 13 is stored.

In the range data storage area 15c, an X coordinate range (from Xmin to Xmax) and a Y coordinate range (from Ymin to Ymax) which represent a graph image display range which is set with respect to a graph image area G (see FIGS. 2 and 6 to 11) of the touch panel display 13 is stored.

In the input equation data storage area 15d, data on a function equation y1=f(x) input by an operation on the key input unit 12 is stored together with data on the display color “blue (br)” of the function equation y1.

In the differential function equation data storage area 15e, data on a differential function equation f′(x) obtained by differentiating the function equation y1=f(x) stored in the input equation data storage area 15d is stored.

In the input equation correspondence tangent slope table 15f, x values (x) of a plurality of points on the graph y1 corresponding to the input function equation y1, and the slopes of tangents yt corresponding the individual points are stored.

In the estimation equation data storage area 15g, data on the function equation y2 of the graph y2 which the user estimates based on the positions where the slopes of the tangents yt corresponding to the plurality of points on the graph y1 are plotted as the plot points PT1, PT2, . . . is stored together with data on the display color “red (re)” of the graph y2.

In the regression equation data storage area 15h, data on the regression function equation y3 which the user designates based on the positions where the slopes of tangents yt to the graph y1 is plotted as the plot points PT1, PT2, . . . is stored together with data on the display color “pink (pi)” of the function equation y3.

In the graph data storage area 15i, data on the graph y1 corresponding to the function equation y1=f(x) stored in the input equation data storage area 15d, data on the graph y2 corresponding to the estimation function equation y2 stored in the estimation equation data storage area 15g, and data on the graph y3 corresponding to the regression function equation y3 stored in the regression equation data storage area 15h are stored as data representing the drawing positions of graph images according to the individual function equations y1, y2, and y3 and data representing the display colors of the individual graph images y1, y2, and y3. Here, the display colors of the graph images y1, y2, and y3 are set to the same colors as the display colors of the corresponding function equations y1, y2, and y3 (for example, the display colors of the function equation y1, y2, and y3 are blue, red, and pink, respectively).

In the slider pattern table 15j, data on the patterns of the sliders SLa, SLb, . . . (see FIG. 10) which are operation display objects for substituting the coefficients a, b, . . . for the individual coefficients (parameters) included in the differential function equation stored in the differential function equation data storage area 15e and designating the values of the coefficients a, b, . . . according to a user's operation is stored together with data on the shape and color of each slider, the number of variable steps according to the knob T of each slider, and the number of variable steps according to left and right buttons dn and up of each slider.

In the slider data storage area 15k, with respect to each of the values of the coefficients a, b, . . . of the sliders SLa, SLb, . . . which are displayed based on the slider patterns, a variable minimum value (Min), a variable maximum value (Max), a current value (Current) a unit change amount (Dot) according to the knob T, and a unit change amount (Step) according to the left and right buttons dn and up are stored.

Also, the unit change amount (Step) according to the left and right buttons dn and up is a numerical-value change amount of a decrease or an increase according to one touch (click) operation on the corresponding left button “←” dn or the corresponding right button “→” up. Apart from this, the unit change amount (Dot) according to the knob T is a numerical-value change amount corresponding to a shift width of one display dot in the shift range (from the minimum value (Min) to the maximum value (Max)) of the corresponding knob T.

Here, a unit change amount (Step) according to one touch (click) operation on the left button “←” dn or right button “→” up of each slider SLa, SLb, . . . is defined as a step unit, and a unit change amount (Dot) corresponding to a shift width of one display dot in the shift range of the knob T of each slider SLa, SLb, . . . is defined as a dot unit.

The CPU 11 controls the operations of the individual circuit units according to commands for various processes described in the calculator control program 14a and software and hardware operate in cooperation with each other, whereby the graph function calculator 10 configured as described above implements various functions to be described in the following operation description.

Subsequently, an operation of the graph function calculator 10 having the above described configuration will be described.

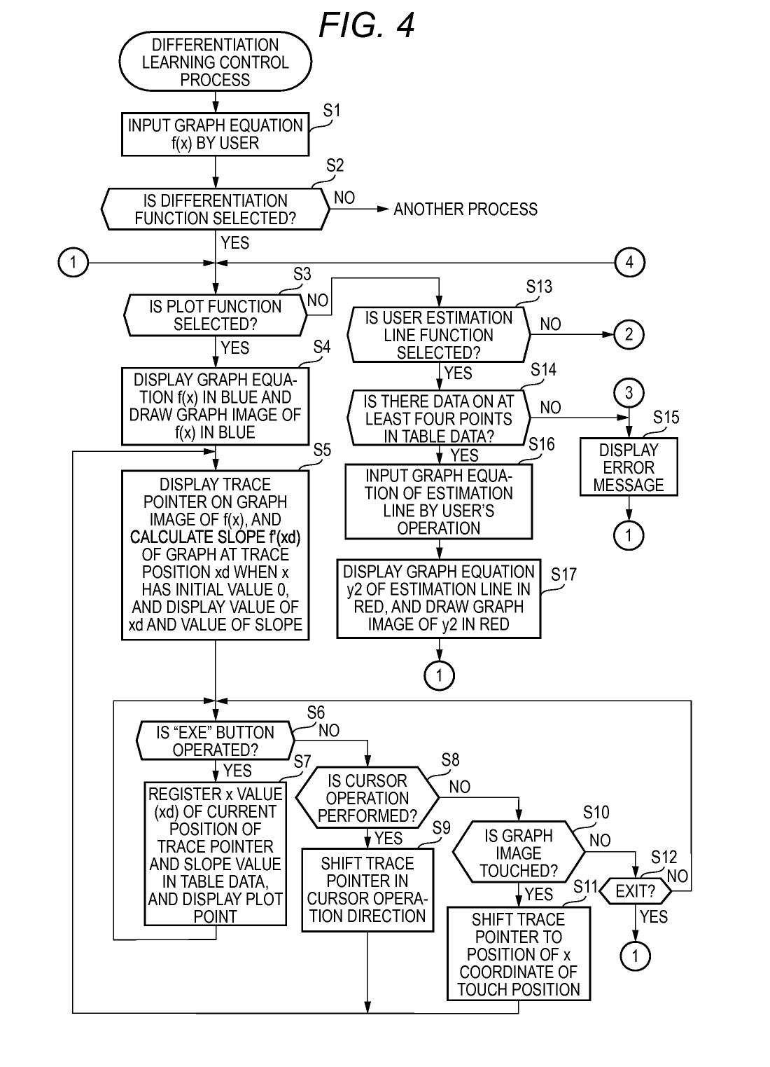

FIG. 4 is a flow chart illustrating a part of a differentiation learning control process which is performed by the differentiation mode of the graph function calculator 10.

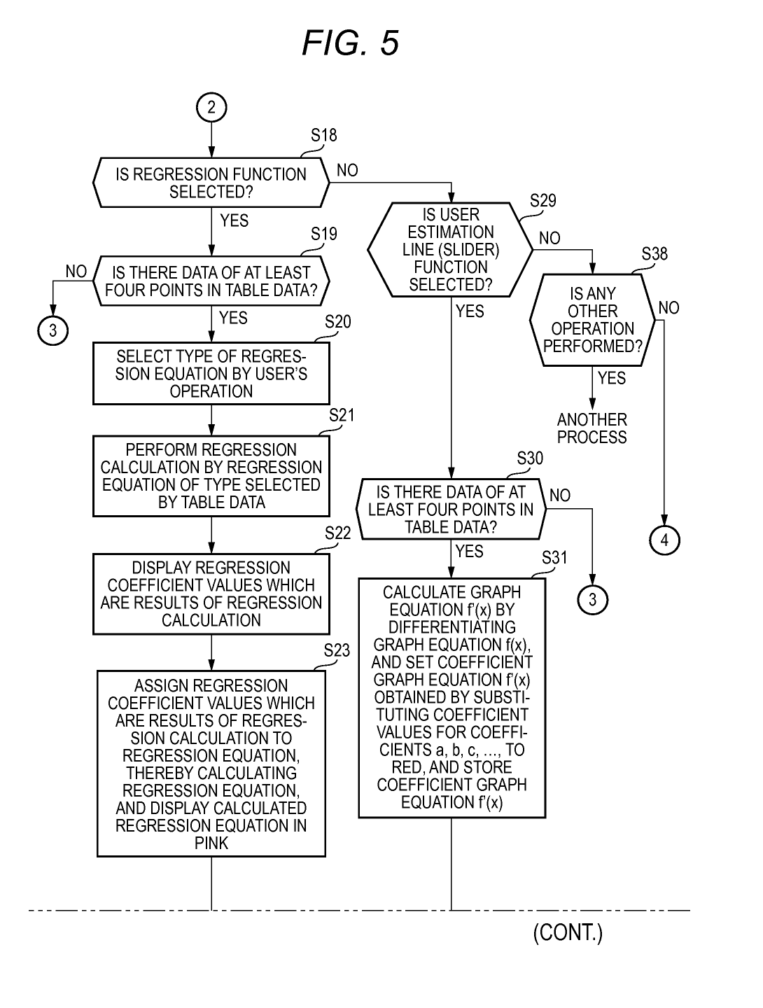

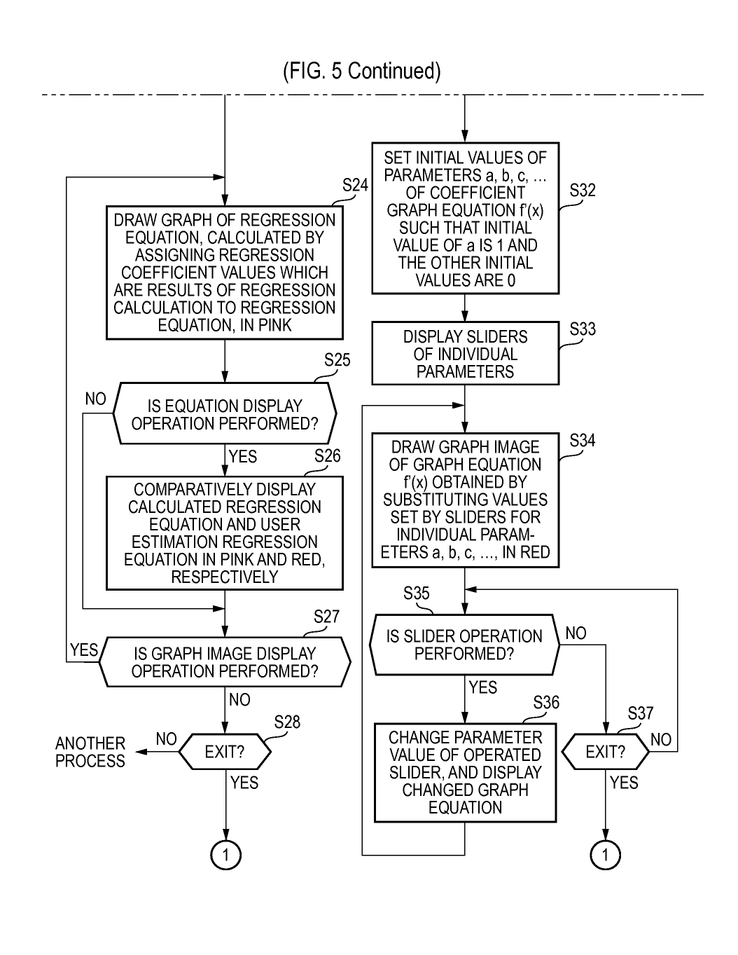

FIG. 5 is a flow chart illustrating another part of the differentiation learning control process which is performed by the differentiation mode of the graph function calculator 10.

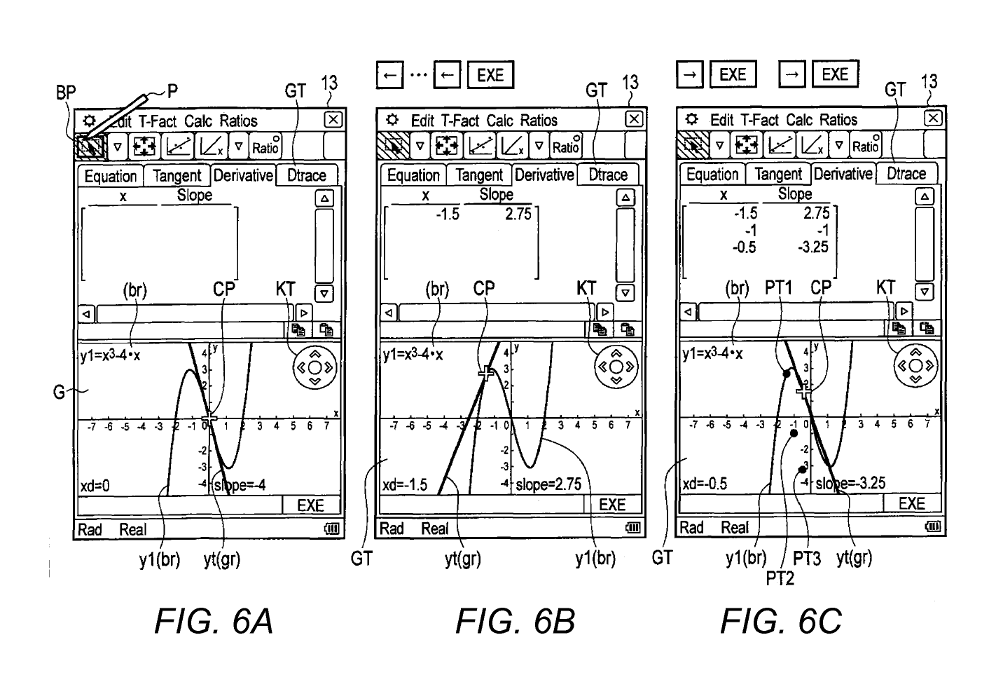

FIG. 6 is a view illustrating a part of a display operation according to user's operations based on the differentiation learning control process of the graph function calculator 10.

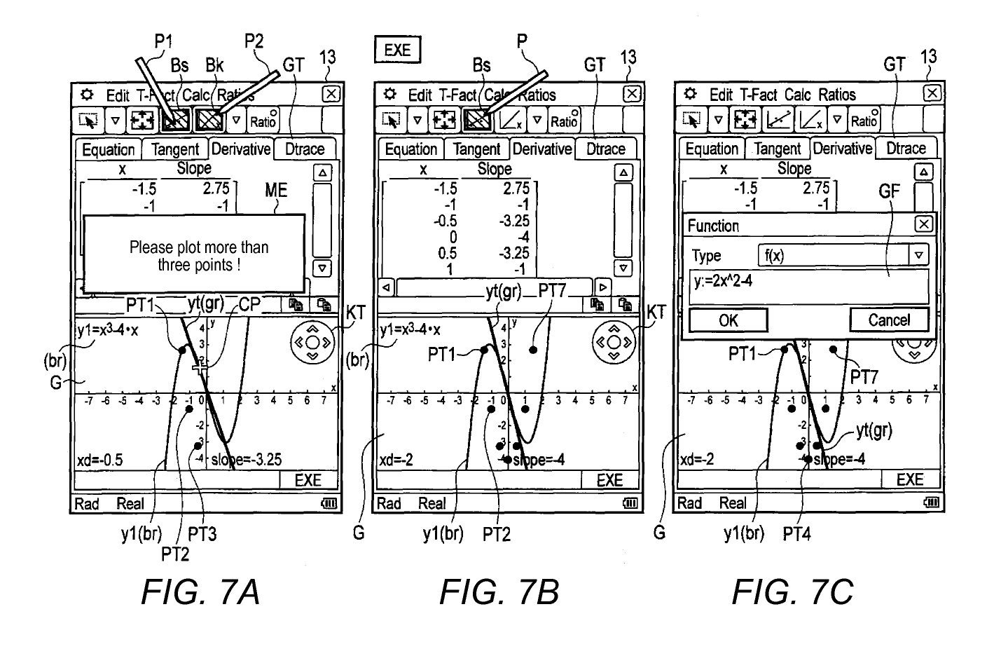

FIG. 7 is a view illustrating another part of the display operation according to the user's operations based on the differentiation learning control process of the graph function calculator 10.

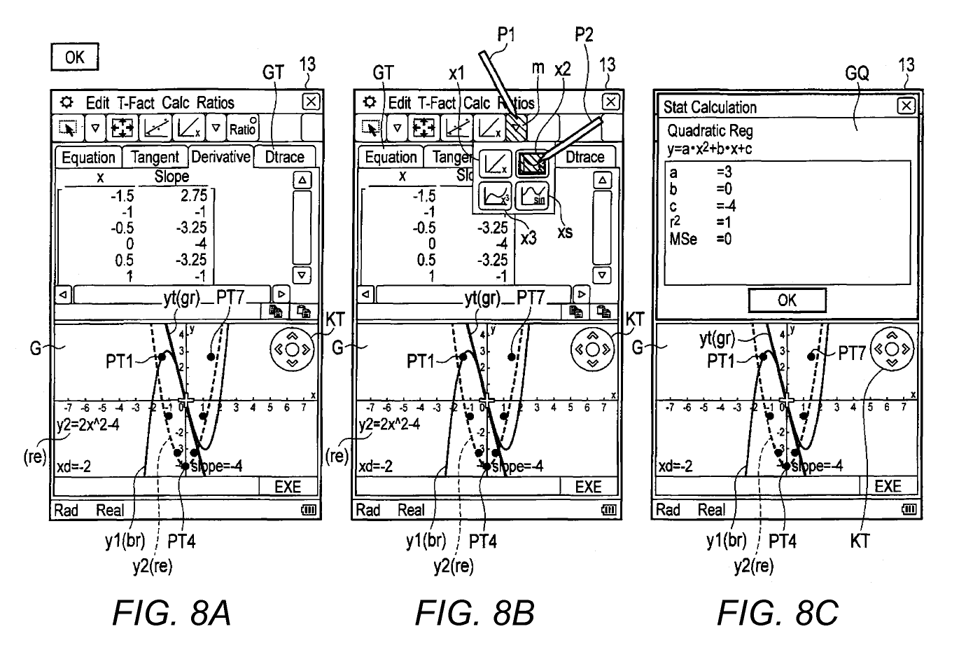

FIG. 8 is a view illustrating another part of the display operation according to the user's operations based on the differentiation learning control process of the graph function calculator 10.

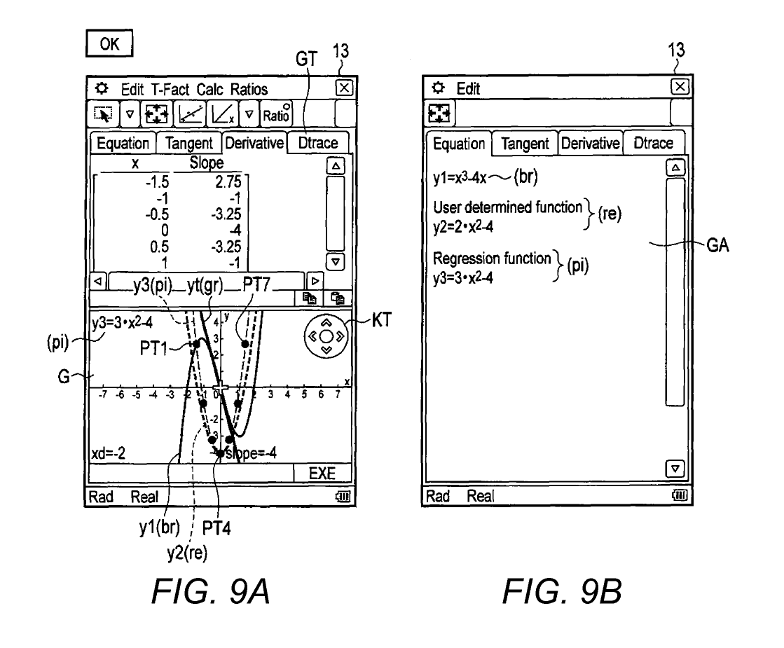

FIG. 9 is a view illustrating another part of the display operation according to the user's operations based on the differentiation learning control process of the graph function calculator 10.

In this differentiation learning control process, if the slopes of tangents yt at points on the graph y1 corresponding to the function equation y1=f(x) are displayed as the plot points PT1, PT2, . . . , the user can experientially learn while understanding that a graph corresponding to the trace of the plotted points PT1, PT2, . . . becomes the graph y3 of an (N−1)-th order function equation y3=f′(x) obtained by differentiating the function equation y1=f(x), by trial and error.

As shown in FIG. 1, if the “Derivative” icon DR of the main menu M displayed on the touch panel display 13 is touched, whereby the graph function calculator 10 is set to the differentiation mode, the differentiation learning control process of FIGS. 4 and 5 is activated.

After the function equation (for example, y1=x³−4x) is input as a differentiation target in response to user's operations on a screen where an equation input function (Equation) of the touch panel display 13 (STEP S1), if a differential function (Derivative) is selected, as shown in FIG. 6A, a graph screen G and a table screen GT are displayed at the lower portion and upper portion of the touch panel display 13, respectively (“Yes” in STEP S2).

Thereafter, if a “Plot” icon Bp is selected from a selection menu displayed along the upper edge of the touch panel display 13 and including icons of various functions arranged therein by a pen touch P (“Yes” in STEP S3), on the graph screen (the function equation “y1=x³−4x” input as a differentiation target is displayed in blue (br) while the graph image y1 corresponding the function equation “y1=x³−4x” is drawn in blue (br) (STEP S4).

Then, a trace pointer CP is displayed at a default position (x=0) on the graph image y1 while a tangent yt corresponding to the position (x=0) of the trace pointer CP is displayed in green (gr), and the slope of the corresponding tangent yt is calculated. Thereafter, the position (xd=0) of the trace pointer CP and the slope “Slope=−4” of the tangent yt are displayed on the graph screen G (STEP S5).

Here, the trace pointer CP displayed on the graph image y1 is shifted in a direction according to a cursor operation and is displayed (“Yes” in STEP S8 and then STEP S9), or is shifted to a position according to a touch operation and is displayed (“Yes” in STEP S10 and then STEP S11), as shown in FIG. 6B.

Then, if an “EXE” button displayed at the lower right of the graph screen G is operated in a state where the user shifts the trace pointer CP on the graph image y1 to an arbitrary position (“Yes” in STEP S6), an x value “xd=−1.5” corresponding to the position of the corresponding trace pointer CP, and the slope value “Slope=2.75” of a tangent yt at the corresponding x value are displayed on the table screen GT and are stored in the input equation correspondence tangent slope table 15f, in association with each other. Also, with this, at a position corresponding to the x value “xd=−1.5” of the trace pointer CP and the slope value “Slope=2.75” of the tangent yt at the corresponding x value, the plot point PT1 is displayed as shown in FIG. 6C. One value of coordinates (for example, “(x, y)=(−1.5, 2.625)”) corresponding to each of a plurality of points on the graph designated in that way is substituted by the slope value (for example, “Slope=2.75”) of the tangent to the graph at the corresponding coordinates, whereby coordinates (for example, “(x, y)=(−1.5, 2.75)”) are obtained, and a point is plotted at the obtained coordinates on a coordinate system where the corresponding graph is displayed (STEP S7).

Also, a multi-touch button KT is displayed on the graph screen (and even by a cursor operation or a touch operation on that button KT, it is possible to perform a performance operation alternative to a shift operation on the cursor pointer CP or an operation on the “EXE” button.

Thereafter, a process of shifting and displaying the trace pointer CP on the graph image y1 according to the cursor operation or the touch operation (STEPS S8 to S11), a process of storing the x value “xd” according to the operation on the “EXE” button and the slope value “Slope” of the tangent yt at the x value “xd” in the input equation correspondence tangent slope table 15f, and a process of displaying the plot point PT2 or PT3 according to those process are repeated (STEPS S6 and S7).

Thereafter, in a state where the plot points PT1 to PT3 are displayed as shown in FIG. 6C, if a “user estimation line” icon Bs for the user to estimate and input a function equation (differential function equation) obtained by differentiating the function equation of a graph according to the plot points PT1 to PT3, that is, the function equation “y1=x³−4x” input as a differentiation target is selected by a pen touch P1 as shown in FIG. 7A (“Yes” in STEP S13), it is determined whether the number of data items corresponding to plot points PTn displayed on the table screen GT and stored in the input equation correspondence tangent slope table 15f is four or more, or not (STEP S14).

Here, in a case where it is determined that the number of data items corresponding to points PTn stored in the input equation correspondence tangent slope table 15f is three or less (PT1 to PT3), and is not four or more (“No” in STEP S14), an error message “Please plot more than three points!” ME indicates that bases for differential function equation estimation are insufficient and thus it is impossible to input the estimation function equation (STEP S15).

Also, even in a case where a “regression calculation” icon Bk for performing regression calculation based on a regression function equation designated by the user, thereby obtaining a function equation (differential function equation) which is obtained by differentiating the function equation “y1=x³−4x” input as a differentiation target is selected by a pen touch P2 (“Yes” in STEP S18), if it is determined that the number of data items corresponding to plot points PTn is three or less (PT1 to PT3), and is not four or more (“No” in STEP S19), an error message “Please plot more than three points!” ME indicates that bases for regression to the differential function equation are insufficient and thus it is impossible to calculate the regression function equation is displayed (STEP S15).

Thereafter, a process of shifting and displaying the trace pointer CP on the graph image y1 according to the cursor operation or the touch operation (STEPS S8 to S11), a process of storing the x value “xd” according to the operation on the “EXE” button and the slope value “Slope” of the tangent yt at the x value “xd” in the table 15f, and a process of displaying the plot point PT4, PT5, . . . according to those processes are repeated (STEPS S6 and S7), whereby, for example, seven plot points PT1 to PT7 are displayed as shown in FIG. 7B. In this state, if the “user estimation line” icon Bs is selected by a pen touch P (“Yes” in STEP S13), it is determined that the number of data items corresponding to plot points PTn is four or more (“Yes” in STEP S14).

Then, as shown in FIG. 7C, an estimation equation input area GF for inputting a function equation (estimation function equation) which the user estimates based on the seven plot points PT1 to PT7 is displayed, whereby the user is urged to input the corresponding estimation function equation (STEP S16).

If the function equation “y=2x²−4” of a graph estimated based on the plot points PT1 to PT7 by the user is input in the estimation equation input area GF and an “OK” button is operated, the input estimation function equation “y2=2x²−4” is stored in the estimation equation data storage area 15g (STEP S16).

Then, as shown in FIG. 8A, on the graph screen G where the blue (br) graph image y1 corresponding to the differentiation target function equation y1, and the plot points PT1 to PT7 of the slopes of the tangents yt are displayed, the input estimation function equation “y2=2x²−4” and the graph image y2 corresponding to the estimation function equation are displayed in red (re) such that they can be identified (STEP S17).

At this time, the red (re) graph image y2 displayed on the graph screen G does not overlap the plot points PT1 to PT7. Therefore, the user can recognize that the input estimation function equation “y2=2x²−4” does not become the differential of the differentiation target function equation “y1=x³−4x”.

Here, in order to perform regression calculation on the regression function equation designated by the user, whereby obtaining the function equation (differential function equation) which is obtained by differentiating the input differentiation target function equation “y1=x³−4x”, if a menu button m of the “regression calculation” icon Bk is selected by a pen touch P1 as shown in FIG. 8B (“Yes” in STEP S18), it is determined that the number of data items corresponding to plot points PTn is four or more (“Yes” in STEP S19), and a selection menu of a “first order regression” icon x1, a “second order regression” icon x2, a “third order regression” icon x3, and a “sin regression” icon xs for selecting a type of regression equation is displayed (STEP S20).

If the “second regression” icon x2 is selected in the selection menu of the four “regression” icons x1, x2, x3, and xs as shown in FIG. 8B by a pen touch P2 (STEP S20), regression calculation is performed based on the data items of the seven plot points PT1 to PT7 stored in the input equation correspondence tangent slope table 15f, by the selected second order regression function equation “y=ax²+bx+c” (STEP S21), whereby the values of the coefficients (parameters) a, b, and c included in the selected second order regression function equation are calculated as shown in FIG. 8C, and the values 3, 0, and −4 of the coefficients a, b, and c are displayed on a second order regression calculation result screen GQ (STEP S22).

Then, as shown in FIG. 9A, on the graph screen G where the graph y1 corresponding to the differentiation target function equation y1 is displayed in blue (br) and the graph image y2 corresponding to the estimation function equation y2 is displayed in red (re), the regression function equation “y3=3x²−4” obtained by substituting the coefficient values 3, 0, and −4 which are the results of the regression calculation for the coefficients a, b, and c is displayed in pink (pi) (STEP S23).

Further, on the graph screen G, the graph image y3 corresponding to the regression function equation “y3=3x²−4” is drawn in pink (pi) (STEP S24).

At this time, the pink (pi) graph image y3 displayed on the graph screen G overlaps the plot points PT1 to PT7. Therefore, the user can recognize that the regression function equation “y3=3x²−4” becomes the differential function equation of the differentiation target function equation “y1=x³−4x”.

Here, if an equation display function (Equation) of the touch panel display 13 is selected in response to a user's operation (“Yes” in STEP S25), as shown in FIG. 9B, an equation confirmation screen GA is displayed such that the differentiation target function equation “y1=x³−4x”, the estimation function equation “y2=2x²−4”, and the regression function equation “y3=3x²−4” are comparatively displayed in blue (br), red (re), and pink (pi), respectively, (STEP S26).

Here, further, if a differential graph display function (Derivative) of the touch panel display 13 is selected in response to a user's operation (“Yes” in STEP S27), as shown in FIG. 9A, the graph screen G is displayed again such that the graph image y1 corresponding to the differentiation target function equation y1, the graph image y2 corresponding to the estimation function equation y2, and the graph image y3 corresponding to the regression function equation y3 are comparatively displayed in blue (br), red (re), and pink (pi), respectively, (STEP S24).

Therefore, according to the differentiation learning control function of the graph function calculator 10 having the above described configuration, if the differentiation target function equation “y1=x³−4x” is input by a user's operation, and the graph image y1 corresponding to the corresponding function equation is displayed, and a point on the graph y1 is designated by the trace pointer CP, a tangent yt to the graph image y1 corresponding to the designated point is displayed while a plot point PT corresponding to the slope value (Slope) of the corresponding tangent yt is displayed. Then, after at least four points on the graph y1 are designated by the trace pointer CP, and the plot points PT1 to PT7 corresponding to the slope values (Slope) of tangents corresponding to the designated points are displayed, if any one regression equation (here, “second order regression” x2) is selected from regression equations of the plurality of types “first order regression” x1, “second order regression” x2, “third order regression” x3, and “sin Regression” xs which are selectable by the menu button m of the “regression calculation” icon Bk, regression calculation using the second order regression function equation “y=ax²+bx+c” selected based on the data items of the plot points PT1 to PT7 is performed, whereby the values of the coefficients (parameters) included in the corresponding regression equation are calculated. Then, the regression function equation “y3=3x²−4” obtained by substituting the coefficient values 3, 0, and −4 calculated by the regression calculation for the coefficients a, b, and c is displayed while a graph image y3 corresponding to the regression function equation y3 is displayed so as to overlap the plot points PT1 to PT7.

Therefore, the use can select the plurality of types of regression equations, and experientially learn while understanding that if the slopes of tangents yt at points on the graph y1 corresponding to the function equation y1=f(x) are plotted as plot points PT1, PT2, . . . , a graph corresponding to the trace of the plotted points PT1, PT2, . . . becomes the graph y3 of the (N−1)-th order function equation y3=f(x) which is obtained by differentiating the function equation y1=f(x), by trial and error.

Also, according to the differentiation learning control function of the graph function calculator 10 having the above described configuration, if the user estimates and inputs the function equation “y2=2x²−4” corresponding to the graph according to the plurality of plot points PT1 to PT7, a graph image y2 corresponding to the estimation function equation y2 is displayed together with the graph screen G in which the plot points PT1 to PT7 and the graph image y3 of the regression function equation y3 are displayed.

Therefore, the user can experientially learn while understanding whether the estimation function equation y2 becomes the differential function equation of the differentiation target function equation y1, or not, according to whether the graph image y2 corresponding to the estimation function equation y2 and displayed on the graph screen G overlap the plot points PT1 to PT7, or not.

Also, according to the differentiation learning control function of the graph function calculator 10 having the above described configuration, on the graph screen G, the differentiation target function equation “y1=x³−4x” and the graph image y1 are displayed in blue (br), and the regression function equation “y3=3x²−4” and the graph image y3 are displayed in pink (pi), and the estimation function equation “y2=2x²−4” and the graph image y2 are displayed in red (re), such that they can be identified. Then, if the equation display function (Equation) is selected in response to a user's operation, only the differentiation target function equation “y1=x³−4x”, the regression function equation “y3=3x²−4”, and the estimation function equation “y2=2x²−4” displayed such that they can be identified are identified and comparatively displayed on the equation confirmation screen GA, and if the differential graph display function (Derivative) is selected, the graph image y1 corresponding to the differentiation target function equation y1, the graph image y3 corresponding to the regression function equation y3, and the graph image y2 corresponding to the estimation function equation y2 are identified and comparatively displayed again. Also, the identification display method is not limited to colors, and a graph image and a corresponding function equation may be displayed with the same concentration such that they can be identified. Also, the line type (such as a solid line, a thick line, or a dotted line) of a graph image and the line type of an underline put under a corresponding function equation may be set to the same type, and the graph image and the function equation may be displayed such that they can be identified.

Also, according to the differentiation learning control function of the graph function calculator 10 having the above described configuration, in a state where the number of plot points PT1, PT2, . . . is less than 4, if an input operation of a regression equation of a graph estimated according to the corresponding plot points PT1, PT2, . . . is performed, an error message “Please plot more than three points!” ME indicates that bases for regression to the differential function equation are insufficient and thus it is impossible to calculate the regression function equation is displayed.

Further, in a state where the number of plot points PT1, PT2, . . . is less than 4, if an input operation of an estimation function equation of a graph estimated according to the corresponding plot points PT1, PT2, . . . is performed, an error message “Please plot more than three points!” ME indicates that bases for regression to the differential function equation are insufficient and thus it is impossible to input the estimation function equation is displayed.

### Other Embodiments

FIG. 10 is a view illustrating a part of a display operation according to user's operations based on another embodiment in the differentiation learning control process of the graph function calculator 10.

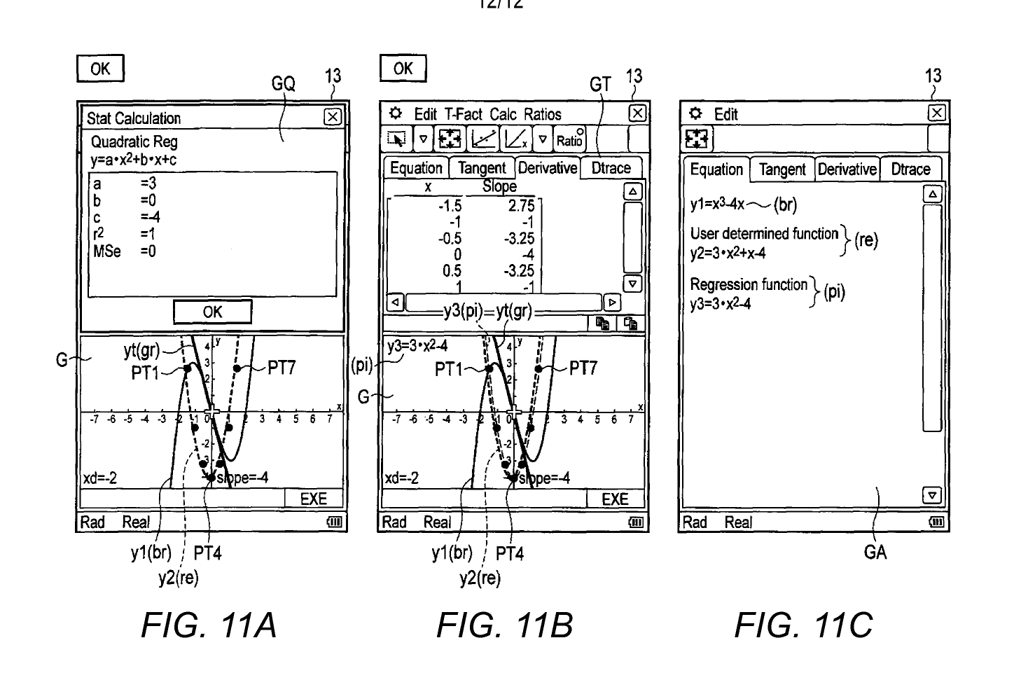

FIG. 11 is a view illustrating another part of the display operation according to the user's operations based on another embodiment in the differentiation learning control process of the graph function calculator 10.

In another embodiment, the differential function equation y3=f′(x) of the differentiation target function equation y1=f(x) is calculated, and the coefficients (parameters) a, b, . . . are substituted for the coefficient values included in the corresponding differential function equation y3=f′(x), whereby the coefficient function equation y2=f′(x) is generated. Then, while the values of the coefficients (parameters) a, b, . . . of the coefficient function equation y2=f′(x) are changed by the sliders SLa, SLb, . . . , the graph image y2 corresponding to the corresponding coefficient function equation y2=f′(x) is operated so as to overlap the plot points PT1 to PT7, whereby it is possible to experientially learn while understanding the differential function equation y3=f′(x) by trial and error.

As shown in FIG. 6A to FIG. 7B, in a state where the differentiation target function equation “y1=x³−4x” and the graph image y1 are displayed in blue (br) while the plot points PT1 to PT7 corresponding to the slope values (Slope) of the tangents yt at the plurality of designated points CP on the graph image y1 are displayed (STEPS S1 to S12), if a “user estimation line (slider)” icon Bs′ is selected as shown in FIG. 10A by a pen touch P (“Yes” in STEP S29), it is determined that the number of data items corresponding to plot points PTn is four or more (“Yes” in STEP S30).

Then, the differential function equation “y3=3x²−4” of the differentiation target function equation “y1=x³−4x” is calculated, and the coefficients a, b, and c are substituted for the coefficient value “3” of the second order term of the corresponding differential function equation y3, the coefficient value “0” of the first order term, and the coefficient value “−4” of the zero order term, whereby the coefficient function equation “ax²+bx+c” is generated, and is displayed in red (re) in an estimation equation input area GF′ (STEP S31).

Thereafter, if the “OK” button is operated, the coefficient function equation “y2=ax²+bx+c” is displayed in red (re) on the graph screen G in which the graph image y1 of the differentiation target function equation y1 and the seven plot points PT1 to PT7 according to the slopes of the tangents yt to the graph image y1 are displayed, as shown in FIG. 10B, and the initial values of the coefficients (parameters) a, b, and c of the coefficient function equation “y2=ax²+bx+c” are set to 1, 0, and 0, respectively (STEP S32).

Then, the sliders SLa, SLb, and SLc for changing the values 1, 0, and 0 of the corresponding coefficients (parameters) a, b, and c in response to user's operations are displayed so as to overlap the table screen GT (STEP S33).

Then, first, the graph image y2 corresponding to the coefficient function equation “y2=x2” obtained by substituting the initial values 1, 0, and 0 set by the sliders SLa, SLb, and SLc for the coefficients (parameters) a, b, and c is drawn in red (re) on the graph screen G (STEP S34).

Thereafter, as shown in FIG. 10C, if the knobs T of the individual sliders SLa, SLb, and SLc are shifted by pen touches P1, P2, and P3, whereby the coefficients a, b, and c are changed, for example, to values 3, 1, and −4, respectively (“Yes” in STEP S35 and then STEP S36), the graph image y2 already displayed in red (re) on the graph screen G is changed to a graph image y2 corresponding to a coefficient function equation “y2=3x²+x−4” obtained by substituting the changed coefficient values for the coefficients, and the changed graph image y2 is drawn (STEP S34).

At this time, the red (re) graph image y2 displayed on the graph screen G is shifted slightly to the left from the plot points PT1 to PT7 so as not to overlap the plot points PT1 to PT7. Therefore, it is possible to recognize that the coefficient function equation “y2=3x²+x−4” obtained by substituting the coefficient values 3, 1, and −4 changed by the sliders SLa, SLb, and SLc at this time for the coefficients a, b, and c does not become the differential function equation of the differentiation target function equation “y1=x³−4x”.

Here, in order to perform regression calculation based on a regression function equation designated by the user, thereby obtaining an function equation (differential function equation) which is obtained by differentiating the differentiation target function equation “y1=x³−4x”, like in the above described embodiment (see FIG. 8B), if the “second order regression” icon x2 is selected from the selection menu of the four “regression” icons x1, x2, x3, and xs by a pen touch P2 (STEPS S18 to S20), regression calculation is performed based on the data items of the seven plot points PT1 to PT7 stored in the input equation correspondence tangent slope table 15f, by the selected second order regression function equation “y=ax²+bx+c” as shown in FIG. 11A (SIP S21), whereby the values of the coefficients (parameters) a, b, and c included in the selected second order regression function equation are calculated, and a regression function equation obtained by substituting values 3, 0, and −4 for the coefficients a, b, and c is displayed on a second order regression calculation result screen GQ (STEP S22).

Then, as shown in FIG. 11B, on the graph screen G where the graph y1 corresponding to the differentiation target function equation y1 is displayed in blue (br) and the graph image y2 corresponding to the coefficient function equation y2 obtained by changing the values of the coefficients (parameters) a, b, and c by the sliders SLa, SLb, and SLc is displayed in red (re), the regression function equation “y3=3x²−4” obtained by substituting the coefficient values 3, 0, and −4 which are the results of the regression calculation for the coefficients a, b, and c is displayed in pink (pi) (STEP S23).

Further, on the graph screen G, the graph image y3 corresponding to the regression function equation “y3=3x²−4” is drawn in pink (pi) (STEP S24).

At this time, the pink (pi) graph image y3 displayed on the graph screen G overlaps the plot points PT1 to PT7. Therefore, the user can recognize that the regression function equation “y3=3x²−4” becomes the differential function equation of the differentiation target function equation “y1=x³−4x”.

Here, if the equation display function (Equation) of the touch panel display 13 is selected in response to a user's operation (“Yes” in STEP S25), as shown in FIG. 11C, an equation confirmation screen GA in which the differentiation target function equation “y1=x³−4x”, the estimation function equation “y2=2x²−4”, and the regression function equation “y3=3x²−4” are comparatively displayed in blue (br), red (re), and pink (pi), respectively, is displayed (STEP S26).

Therefore, according to the differentiation learning control function of another embodiment of the graph function calculator 10 having the above described configuration, the differential function equation y3=f′(x) of the differentiation target function equation y1=f(x) is calculated, and the coefficients (parameters) a, b, . . . are substituted for the coefficient values included in the corresponding differential function equation y3=f′(x), whereby the coefficient function equation y2=f′(x) is generated. Further, while the values of the coefficients (parameters) a, b, . . . of the coefficient function equation y2=f′(x) are changed by the sliders SLa, SLb, . . . , the graph image y2 corresponding to the corresponding coefficient function equation y2=f′(x) is operated so as to overlap the plot points PT1 to PT7, whereby it is possible to experientially learn while understanding the differential function equation y3=f′(x) by trial and error.

Also, the method of each process of the graph display control apparatus described in each above described embodiment, that is, each method according to the differentiation learning control process shown in the flow chart of FIG. 4 or 5 can be stored, as a program executable in any computer, in a medium of an external recording device such as a memory card (such as a ROM card or a RAM card), a magnetic disk (such as a floppy disk or a hard disk), an optical disk (such as a CD-ROM or a DVD), or a semiconductor memory to be distributed. Further, a computer (control apparatus) of an electronic device having a display capable of user input reads the program stored in the medium of the external storage device into a storage device, and its operation is controlled by the read program, whereby it is possible to implement the differentiation learning control function described in each above described embodiment, and to implement the same process according to the above described method.

Also, program data for implementing each above described method can be transmitted as a program code on a communication network, and the program data can be fetched from a computer device (a program server) connected to the communication network into an electronic device having a display capable of user input, and be stored in a storage device, thereby implementing the above described differentiation learning control function.

The present invention is not limited to the above embodiments, and can be modified in various forms in the implementation phase, without departing from the spirit or character thereof. The embodiments each include inventions of different stages and therefore various inventions can be extracted by combining suitably a plurality of structural requirements disclosed in the embodiments. For example, even if some are removed from all of the structural requirements shown in the embodiment or some structural requirements are combined in a different mode, the resulting configuration can be extracted as an invention, provided that the object to be achieved by the invention is accomplished and the effect of the invention is obtained.

What is claimed is:

1. A graph display control apparatus comprising:
a processor,
wherein the processor operations including:
storing a function equation in a memory;
displaying a graph corresponding to the stored function equation on a coordinate system of a display;
designating a plurality of points on the displayed graph in response to user's operations;
obtaining a slope value of a tangent to the displayed graph at each coordinate corresponding to each of the plurality of designated points;
plotting the corresponding slope values as one value of a coordinate on the coordinate system;
performing regression calculation based on the plurality of plotted points to obtain a regression function equation of a graph corresponding to the plurality of plotted points; and
displaying a graph corresponding to the regression function equation obtained by the regression calculation on the display.

2. The graph display control apparatus according to claim 1,
wherein the plotting operation in the processor includes;
substituting one value of a coordinate with the corresponding slope value; and
plotting a point at the substituted coordinate on the coordinate system.

3. The graph display control apparatus according to claim 1,
wherein the processor further operations including:
displaying the graph corresponding to the regression function equation by overlapping with the plurality of plotted points, on the display.

4. The graph display control apparatus according to claim 1,
wherein the processor further operations including:
inputting an estimation function equation corresponding to a graph which is estimated based on the plurality of plotted points by a user; and
displaying the graph corresponding to the input estimation function equation together with the displayed graph corresponding to the regression function equation, on the display.

5. The graph display control apparatus according to claim 4,
wherein the processor further operations including:
displaying the regression function equation and the estimation function equation in different display forms to be identified on the display;
displaying the graph corresponding to the regression function equation obtained based on the regression calculation in the same display form of the corresponding regression function equation displayed to be identified; and
displaying the graph corresponding to the input estimation function equation in the same display form of the corresponding estimation function equation displayed to be identified.

6. The graph display control apparatus according to claim 4,
wherein the processor further operations including:
selecting an arbitrary regression function equation from a plurality of types of regression function equations in response to a user's operation; and
performing regression calculation based on the plurality of plotted points by using the selected regression function equation.

7. The graph display control apparatus according to claim 1,
wherein the processor further operations including:
determining whether the number of the plotted points is less than four; and
displaying an error message on the display when the number of the plotted points is determined to be less than four in a case where the regression calculation is performed.

8. The graph display control apparatus according to claim 4,
wherein the processor further operations including:
determining whether the number of the plotted points is less than four; and
displaying an error message on the display when the number of the plotted points is determined to be less than four in a case where the estimation function equation is input.

9. The graph display control apparatus according to claim 4,
wherein the input estimation function equation is a function equation including coefficients,
the processor further operations including:
displaying operation display objects which changes and sets values of the coefficients included in the estimation function equation, on the display in response to user's operations;
substituting the coefficients included in the input estimation function equation with the values set by the operation display objects; and
displaying a graph corresponding to the estimation function equation obtained by substituting the values for the coefficients, together with the displayed graph corresponding to the regression function equation on the display.

10. A graph display control method of an electronic device having a display and a memory, comprising:
storing a function equation in the memory;
displaying a graph corresponding to the function equation stored in the memory on a coordinate system of the display;
designating a plurality of points on the graph displayed on the display, in response to user's operations;
obtaining a slope value of a tangent to the displayed graph at each coordinate corresponding to each of the plurality of designated points;
plotting the corresponding slope values as one value of a coordinate on the coordinate system;
performing regression calculation based on the plurality of plotted points to obtain a regression function equation of a graph corresponding to the plurality of plotted points; and
displaying a graph corresponding to the regression function equation obtained by the regression calculation.

11. The graph display control apparatus according to claim 1, comprising:
the memory and the display.

12. A non-transitory computer readable storage medium having stored therein instructions, which when executed by a device having a display and a memory, cause the device to function as units comprising:
a function equation storing unit that stores a function equation in the memory;
a graph display unit that controls the display to display a graph corresponding to the function equation stored in the memory on a coordinate system of the display;
a graph point designating unit that designates a plurality of points on the graph displayed on the display, in response to user's operations;
a slope coordinate plotting unit that obtains a slope value of a tangent to the displayed graph at each coordinate corresponding to each of the plurality of designated points and that plots the corresponding slope values as one value of a coordinate on the coordinate system;
a regression calculation unit that performs regression calculation based on the plurality of points plotted by the slope coordinate plotting unit to obtain a regression function equation of a graph corresponding to the plurality of plotted points; and
a regression graph display unit that controls the display to display a graph corresponding to the regression function equation obtained by the regression calculation of the regression calculation unit.
